(19) United States
(12) Patent Application Publication
(10) Pub. No.: US 2004/0234315 A1
(43) Pub. Date: Nov. 25, 2004

(54) Method and computer-readable medium for faster data entry

(76) Inventors: Steven Lee Colwell, Santa Barbara, CA (US); Judith Luckay Colwell, Santa Barbara, CA (US)

Correspondence Address: Steven Lee Colwell, 2265 Las Canoas Rd, Santa Barbara, CA, 93105, US

(21) Appl. No.: 10/848,316

(22) Filed: May 18, 2004

Related U.S. Application Data
(60) Provisional application No. 60/472,243, filed on May 20, 2003.

(51) Int. Cl. B41J 5/16

(52) U.S. Cl. 400/489

(57) ABSTRACT

A method to enable faster invocation of functions without slowing data entry. Key presses are processed so that the symbols and letters are entered into the text as usual, while allowing the typist to perform special functions by using common key presses in sequences that don't occur during regular typing. In one embodiment, the typist can correct an error in the last word typed with a single press of the semicolon key, rather than having to press the backspace key multiple times.

### CROSS-REFERENCE TO RELATED APPLICATIONS

This application claims the benefit of U.S. Provisional Application No. 60/472243, filed May 20, 2003, the contents of which are incorporated herein in its entirety.

### STATEMENT REGARDING FEDERALLY SPONSORED RESEARCH OR DEVELOPMENT

Not applicable.

### REFERENCE TO COMPUTER PROGRAM LISTING APPENDIX

A compact disc is provided which contains a computer program listing appendix to this application. The appendix contains three ascii-text files, named patent.dpr, unit1.dfm, and unit1.pas. These are complete source code for a working example of a preferred embodiment. This source code can be compiled using version 5 of the programming language Delphi from Borland. A copy of the compact disc is provided, giving a total of two compact discs.

### BACKGROUND

1. Field of Invention

The present invention relates generally to data entry, and more specifically to faster entry of data into a computer.

2. Description of the Related Art

Entering of text into a computer is a time-consuming process. A prime reason is the frequent need to type hard-to-reach keys like the backspace or shift key. Some efficiency problems with the backspace key are:

1. it is harder for a touch-typist to reach than a home-row key;

2. it must be pressed multiple times to erase each letter of the text back to the error point; and

3. after erasure the new typing position is often in the middle of a word; retyping starting in the middle of a word requires more mental effort from the typist.

Partially-effective improvements exist for the backspace key. For instance, some special keyboards physically position the backspace key in an easier-to-reach location on the keyboard, such as the Kinesis Contour keyboard which has the backspace key placed near the typist's thumb. This approach solves problem 1 in the list above, but not problems 2 and 3; also, this technique won't work with standard keyboards.

Another improvement method is to use special multi-key combinations to indicate whole-word corrections. For instance, in Microsoft Word, the two-key combination ctrl-Backspace erases the previous word, and the three-key combination ctrl-shift-left-arrow selects the previous word. These solve problems 2 and 3 above, but require pressing of multiple keys, all of which are harder to reach than home-row keys.

Another method is to use the mouse to indicate corrections. In modern graphical user interfaces, a double-click selects an entire word, and a click-and-drag selects a portion of a text. These mouse methods solve problems 2 and 3 above, but having to position the mouse and move the hand from the mouse to the keyboard greatly slows the typist.

Typing a period and two spaces at the end of a sentence requires three key presses. A question mark or exclamation point requires an additional key press for the shift key, which is slow not only because the shift key is not on the home row, but because having to hold down one key while typing another makes the overall sequence more difficult and slows the typist. Reducing the number and difficulty of these key presses at the ends of sentences would improve typing speed.

Others have addressed this, but the solutions are imperfect. For instance the Intellikeys Smart Typing feature inserts two spaces after a period, question mark, or exclamation point is typed. But this method doesn't allow the user to insert these symbols elsewhere in the text; for instance, in an abbreviation like i.e. or a web address like typewell.com. Also, this method requires the typist to use the difficult-to-reach shift key in order to enter the question mark and exclamation point.

Thus, there is a need for a better solution that reduces the need for typists to use hard-to-reach keystrokes in order to allow quicker data entry.

### SUMMARY OF THE INVENTION

We have invented a method to enable faster invocation of functions without slowing data entry. Key presses are processed so that the symbols and letters are entered into the text as usual, while also allowing the typist to perform special functions by using common key presses in sequences that don't occur during regular typing. For instance, in one embodiment, the typist can correct an error in the last word typed with a single press of the semicolon key, rather than having to press the backspace key multiple times.

Our invention is superior to the prior art because:

a function may be activated with a single key press;

the single key press may be chosen to be easy for a touch typist to reach;

the single key press may be a standard typing character in order to provide access to functions without a dedicated function key; and

regular text entry is unaffected.

In one embodiment, the initiation character is the semicolon. On the QWERTY keyboard the semicolon is on the home row directly under one of the fingers of a touch typist. The semicolon is much faster for a touch typist to type than other common choices for function keys, such as ctrl-backspace, or a function key like F3. In this embodiment, pressing the semicolon key inserts the semicolon character into the text as usual. If the next key typed is a space, a space being the usual prose character following a semicolon, then the characters are inserted into the text as normal. But if the next key typed is a letter, which never directly follows a semicolon in English prose, then the semicolon is used as a function key, in this case to erase the last word typed.

From the user's point of view, this embodiment allows one-key selection of the last word typed, in order to retype it after an error is made. This is much faster than pressing the backspace key multiple times, or the complex ctrl-Backspace multikey sequence, for the same result. Yet typing a regular use of a semicolon followed by a space is interpreted as usual as text entry, so there is no adverse impact on the typing of users who do not know about the semicolon editing feature.

In another embodiment, a keystroke is saved in typing the punctuation at the end of a sentence. A user may type two spaces at the end of a sentence, without typing the period, and the embodiment will insert the period if it's not already there. This is fast because the space key is the biggest key on the keyboard, and is the easiest key to type. Furthermore, the punctuation-adjustment is retracted when more than 3 spaces are pressed, so that any natural data entry task involving items separated by groups of spaces, will work as before. Again, there is no adverse impact on the typing of users who do not know about the special sentence-punctuation feature.

Similarly, in this embodiment a user may save a keystroke in typing a question mark at the end of a question sentence, by typing a slash and two spaces. The embodiment will change the slash into a question mark. On the QWERTY keyboard, the slash is the same key as the question mark, so to the user this is easy to use, a simple matter of leaving out the shift key when typing a question mark. The embodiment checks the preceding text to verify that the slash is meant to be a question mark rather than some typical use of a slash such as the end of a web site URL. The embodiment also retracts the change if the user types more than 3 spaces. Again, unaware users are not adversely affected by the feature.

In summary, the invention enables special editing functions, and other non-editing functions, to be performed using very easy to reach keystrokes, on existing keyboards, without precluding use by untrained users.

### BRIEF DESCRIPTION OF THE DRAWINGS

Embodiments of the present invention will now be described with reference to the drawings summarized below. These drawing and the associated description are provided to illustrate example embodiments of the invention, and not to limit the scope of the invention.

FIG. 1 illustrates an example computer system that can be used in accordance with one embodiment of the present invention.

FIGS. 2A-D illustrate an example word correction operation.

FIGS. 3A-D illustrate an example multiple-word correction operation.

FIGS. 4A-C illustrate an example word correction operation initiated by a semicolon after a space.

FIGS. 5A-C illustrate an example retraction of a word correction retractable function.

FIGS. 6A-D illustrate an example retraction of a multiple word correction retractable function.

FIGS. 7A-C illustrate an example sentence-end adjustment with a period.

FIGS. 8A-D illustrate an example sentence-end adjustment with a question mark.

FIG. 9 is a flow chart illustrating an example word correction process.

FIG. 10 is a flow chart illustrating an example sentence-punctuation adjustment process.

FIG. 11 is a state diagram illustrating the state of function activation as characters are processed for an exemplary embodiment.

### Throughout the drawings, like reference numbers may be used to refer to items that are identical or functionally similar.

### DETAILED DESCRIPTION OF PREFERRED EMBODIMENTS

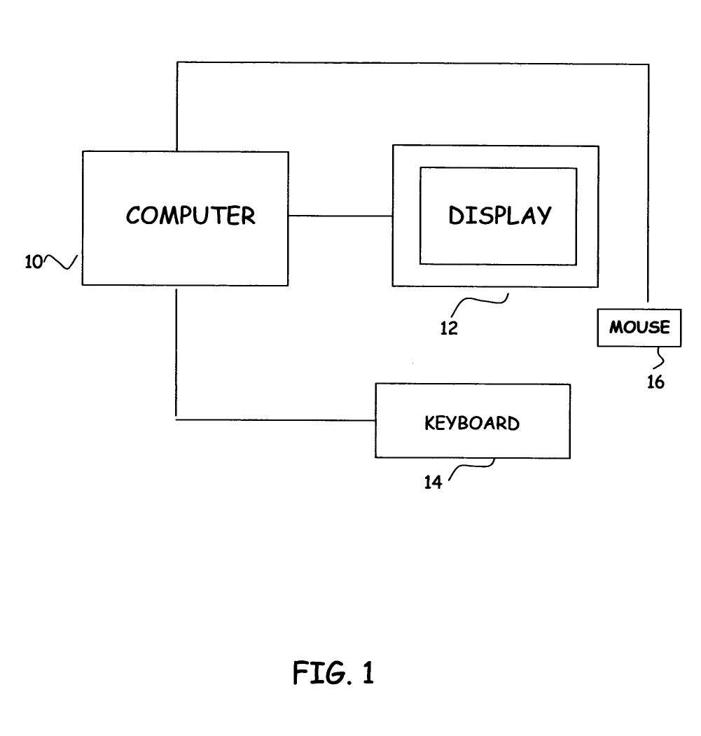

Unless otherwise indicated, the functions described herein are preferably performed by software modules including executable code and instructions running on one or more general-purpose computers. An exemplary embodiment of the invented apparatus is shown in FIG. 1. It comprises a computer 10 for receiving data from input devices such as a keyboard 14 or mouse 16, and for transmitting data to an output device such as a display 12. The computer also stores program steps for program control of the invented method, and manipulates data in memory.

However, the present invention can also be implemented using special purpose computers, state machines, and/or hardwired electronic circuits. In addition, the example processes described herein do not necessarily have to be performed in the described sequence, and not all states have to be reached or performed. Further, while the following description may refer to “clicking on” a text element, or pressing a key on a keyboard in order to enter a character, the data entry can also be made using other data entry devices, such as using voice input, pen input, touch-screen, mousing or hovering over an input area, and/or the like.

### DETAILED DESCRIPTION OF EXAMPLE DISPLAYS

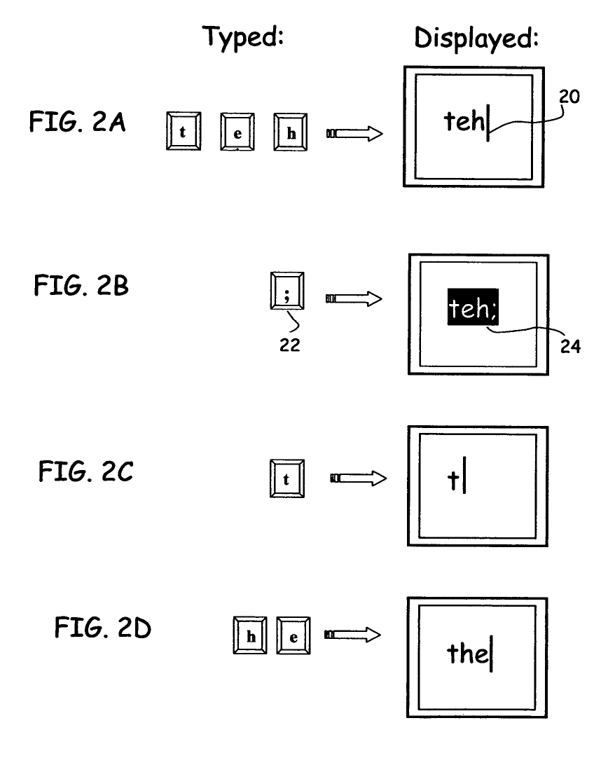

FIG. 2A shows the display of one embodiment after the keys t, e, and h are struck. The letters are displayed with a cursor 20 indicating where the next letter will be inserted into the text.

FIG. 2B shows the next display of this embodiment after the semicolon key 22 is pressed. The semicolon is inserted into the text normally, and the semicolon and the preceding word are selected in a selection region 24. A selection region is a standard method in the art for indicating what text will be replaced by the next keystroke. In order to more clearly explain the examples, we herein refer to the standard concepts from the art of a text comprising a sequence of characters with a cursor position or selection region displayed on a graphical display. These standard user-interface concepts are used for clarity of explanation, but the reader will understand that this does not limit the scope of the invention to uses involving these specific concepts.

In the embodiment in FIG. 2B, the selected text will be replaced when any character other than a space is pressed next. Once the selection region 24 appears as a result of the semicolon 22 being pressed, it proceeds to act in the standard way in FIG. 2C, which shows the display after the letter t is pressed, and FIG. 2D after the corrected word “the” has been retyped.

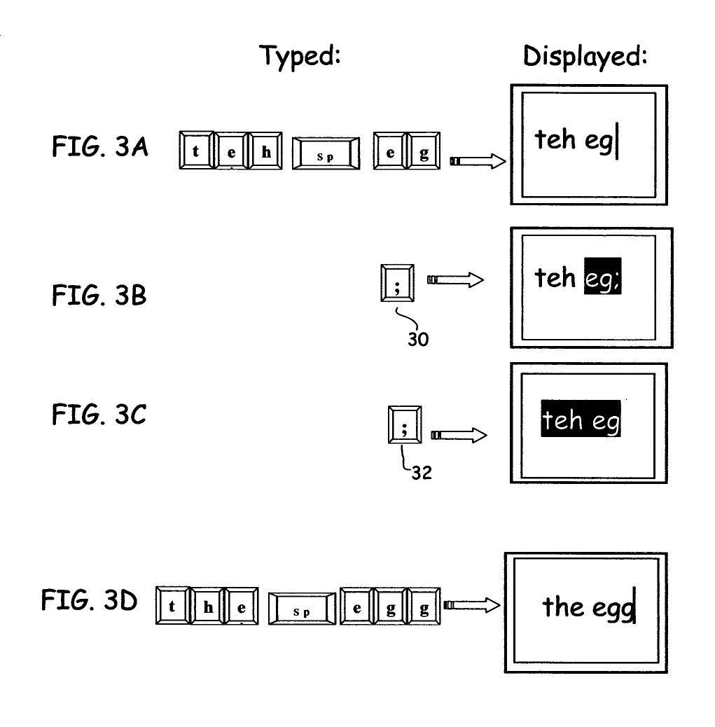

FIGS. 3A-3D show an example where the error to be corrected is two words back. In FIG. 3A two words are entered. In FIG. 3B a first semicolon 30 is typed and the latter word selected, and in FIG. 3C a second semicolon 32 is typed and the selection region grows to encompass both words. When the second semicolon 32 is typed, the first semicolon 30 is removed from the selection region. In this example embodiment, repeated pressing of the semicolon selects additional words: for example, pressing the semicolon a third time after the second semicolon 32 would have highlighted a third word back. In FIG. 3D following typing is shown replacing the selected words.

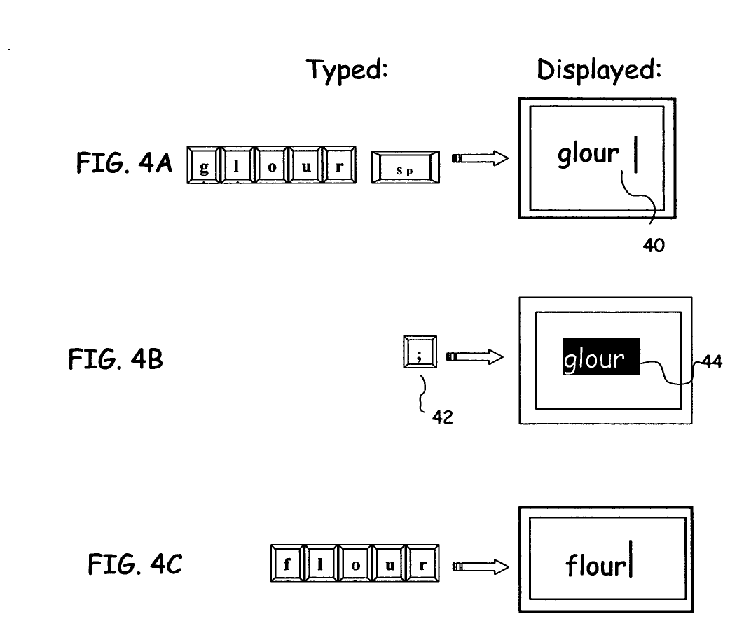

FIG. 4A shows a word and a space 40 being typed. When in FIG. 4B a semicolon 42 is typed, the selection region 44 is selected. In this example embodiment, because the use of a semicolon after a space is never correct in English prose, the semicolon is removed automatically. The selection region 44 encompasses the previous word and the space character 40. FIG. 4C shows the selected text being replaced by the newly typed word “flour”.

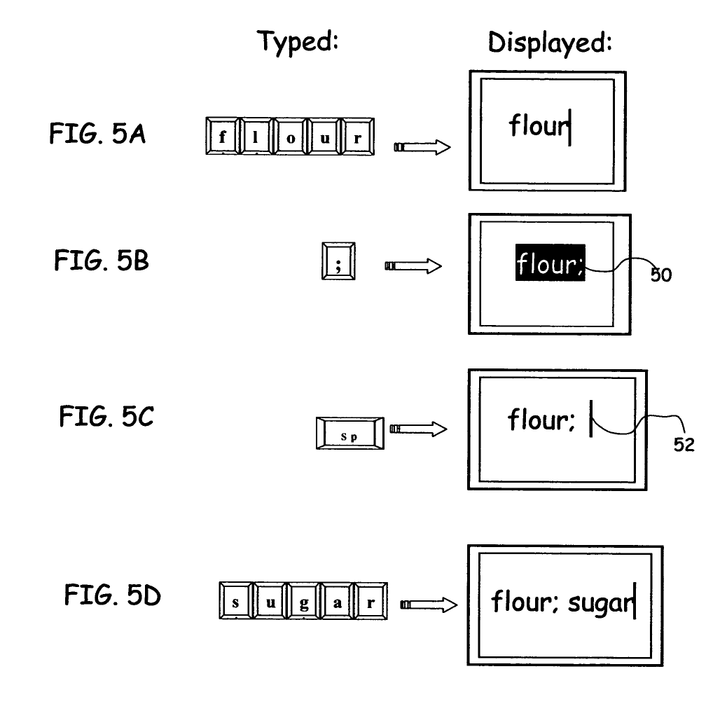

FIGS. 5A-5D show another non-standard behavior of the selection region. FIG. 5A shows a word being typed. FIG. 5B then shows a semicolon being typed and inserted into normal text. The selection region 50 automatically encompasses both the semicolon and the preceding word, as in the prior examples. Now note that when a space is typed in FIG. 5C, the selection region 50 is retracted, and a space is inserted at the cursor 52, so that the display in FIG. 5C is exactly as it would have been in normal typing of the semicolon and space. FIG. 5D shows typing of the next word being inserted normally into the text.

The retraction in FIG. 5C is an important part of this embodiment. In one keystroke the selection is removed, the space which was the retraction character is inserted into the text; and the semicolon that initiated the selection is also retained. The result is that typing semicolon and then space has the same effect in this embodiment as it would in a standard text entry system. The special function that was initiated by the semicolon in FIG. 5B has been fully retracted, so it's as if it never occurred.

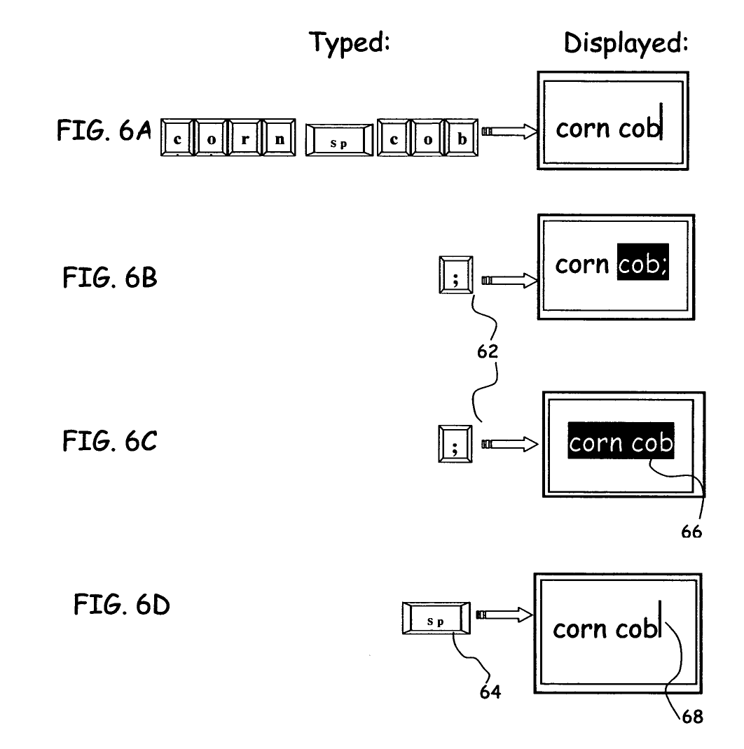

FIG. 6A shows two words being typed. In FIG. 6B, a first semicolon 62 is typed and one word selected, then in FIG. 6C a second semicolon 62 is typed and the selection 66 is extended to contain both words. In FIG. 6D the space 64 moves the cursor 68 to the point after the selected area 66, and normal typing can proceed. In this embodiment, the space is a termination character that terminates the function initiated by the two semicolons. The semicolons are not inserted into the text, making this a termination of the function rather than a retraction. This gives the typist a way to change his or her mind about erasing a multiword selection, with only one keystroke, the space key.

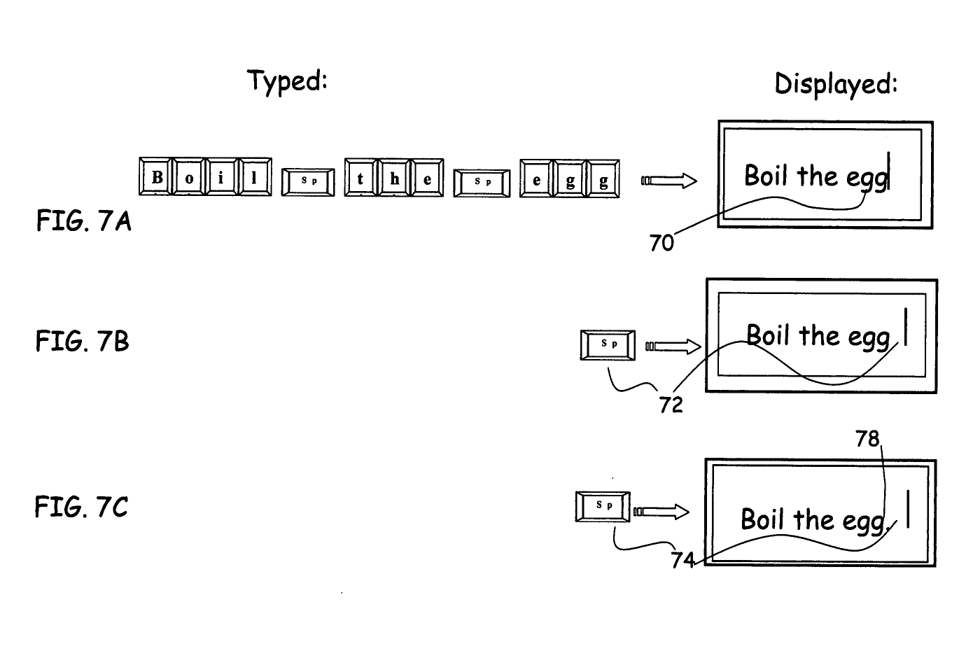

FIGS. 7A-7C show an example where a period is being added automatically to the end of a sentence. The sentence is first typed in FIG. 7A. Then FIG. 7B and FIG. 7C show two spaces 72 and 74 being typed after the final word 70 of the sentence. When the second space 74 is typed, the presence of a preceding space 72 with no punctuation preceding it is detected, and a sentence-punctuation adjustment is made by automatically inserting a period 78 at the end of the sentence. A sentence-punctuation adjustment is a change to the punctuation characters of a sentence, and may refer to the beginning of a sentence as well as the end, for example in an embodiment for a language like Spanish where some sentence punctuation, the question mark, appears at the start of the sentence.

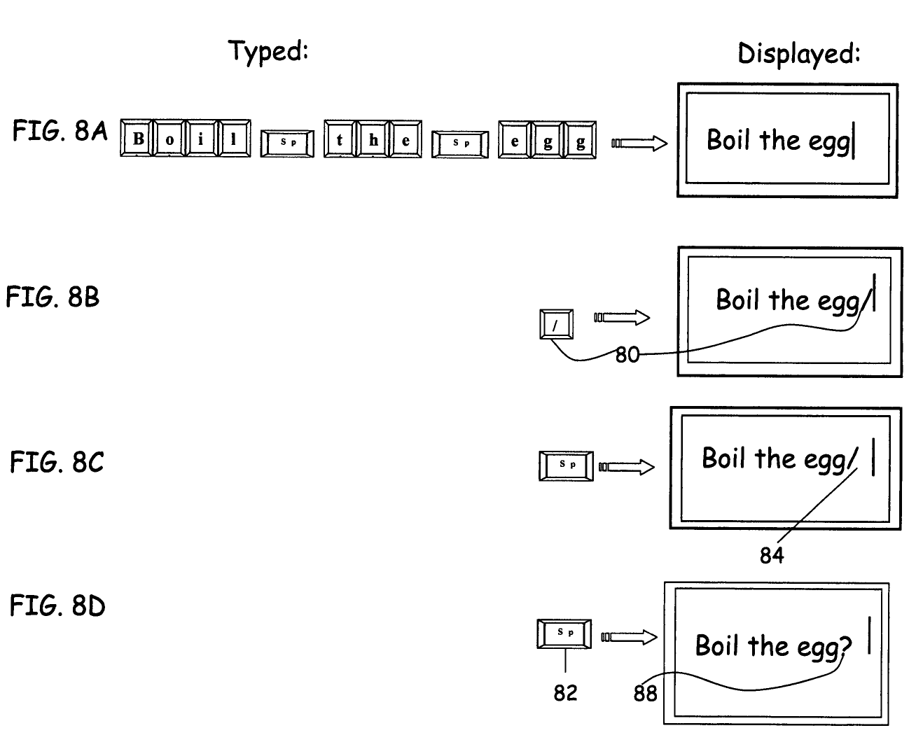

FIGS. 8A-8D show an example where a sentence is being modified by adding a question mark to the end of the sentence. After typing a phrase in FIG. 8A, the typist types a slash 80 in FIG. 8B, followed by two spaces in FIG. 8C and FIG. 8D. When the second space 82 in FIG. 8D is typed, the preceding space 84 from FIG. 8C, and slash 80 from FIG. 8B are detected, and the situation recognized as needing an adjustment to the sentence punctuation. As a result the slash 80 is changed to a question mark 88 in FIG. 8D.

### DETAILED DESCRIPTION OF FLOW CHARTS

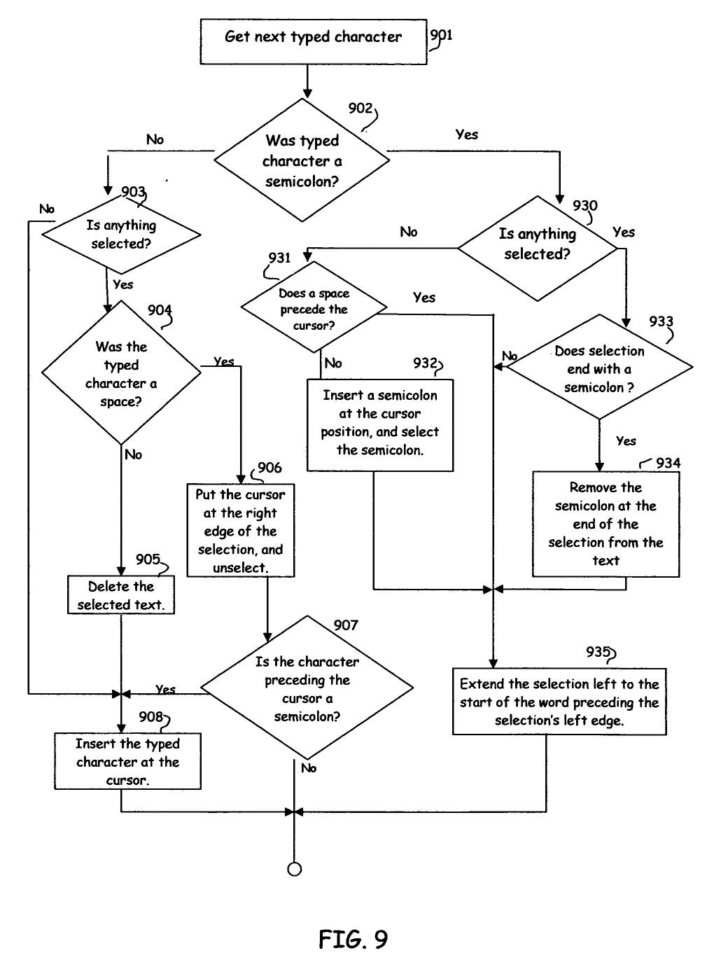

FIG. 9 illustrates how the display in an exemplary embodiment is updated as each character is typed. Some text may already present as in FIG. 2A, and in state 901 a further next character is entered by the user. For an English language data-entry device, a character may be a letter, digit, symbol such as less-than, space character, or a punctuation symbol such as a colon, comma, or single-quote. In other embodiments, characters are from a specialized alphabet according to the domain of the data-entry device, such as a Unicode symbol from a Chinese character-entry system, or a musical note from a piano keyboard. Keystrokes that have no displayable representation are not characters, such as ctrl-C or backspace in the domain of an English prose text editor.

State 902 determines whether the character was the initiation character or not. In this example the initiation character is the semicolon. If a semicolon was typed, then in state 930 the selection region is examined to see if it contains any characters. If it contains no characters, as illustrated at 20 in FIG. 2A, then state 931 determines whether the character just to the left of the cursor is a space. If not, as illustrated at 20 which has the letter h to the left of the cursor, then in 932 a semicolon is inserted at the cursor position, and the selection region is set to encompass that single semicolon character. Then at state 935 the selection region is extended left to encompass the preceding word, giving a larger selection region which encompasses the semicolon character as well as the preceding word, as illustrated in FIG. 2B.

If at state 931 a space precedes the cursor, as illustrated in FIG. 4A, state 932 is skipped and the semicolon key is not inserted into the text. In this case the selection region is extended in 935 to encompass just the word preceding the cursor, as illustrated in FIG. 4B.

If at state 930 the selection region contained some text as illustrated in FIG. 3B, then in state 933 if the selection region ends with semicolon, then the newly typed semicolon causes a modification of the selection region. The previously entered semicolon character is erased from the text at state 934, and then the selection region is expanded one word more to the left in state 935, giving an extended selection region as illustrated in FIG. 3C. If in state 933 the selection region ends with a character other than a semicolon, then the selection region is expanded one more word to the left in state 935 without removing any characters from the selection region.

If the character from state 901 is not a semicolon, and no text was contained in the selection region at state 903, then at state 908 the character from 901 is added to the text at the cursor position, as illustrated in FIG. 2D. If a non-semicolon is typed while text is selected, then state 904 determines whether the typed character was a space. If not, as when the t is entered in FIG. 2C, the selected text 24 is deleted in state 905, and the new letter inserted at the cursor at state 908. If at state 904 the typed character is a space, as illustrated in FIG. 5C, then at state 906 the cursor is moved to the right edge of the selection region, and if the final character of the selection region is a semicolon, a space is added, giving a new cursor position 52 following the space.

If at state 907 and as illustrated in FIG. 6D, the last character in the selection region is not a semicolon, then the newly typed space character 64 is not inserted at the cursor 68, and the cursor remains at the end of the selection region. The space character acts to unselect the selected text, and isn't inserted as a character in its own right.

The initiation key sequence may be any key that is always followed by a restricted set of characters, for the application domain chosen. For instance, in the domain of typing English prose, the semicolon key is always followed by a space or the end of a line. Thus in applications concerned primarily with typing English prose, any use of the semicolon key followed by a letter or digit key indicates a special function usage has begun. Another example is when typing numbers into a spreadsheet, where the comma key might be followed by a digit, in a number such as 12,345. In applications concerned with numeric entry, any comma followed by a letter key indicates a special function usage has begun.

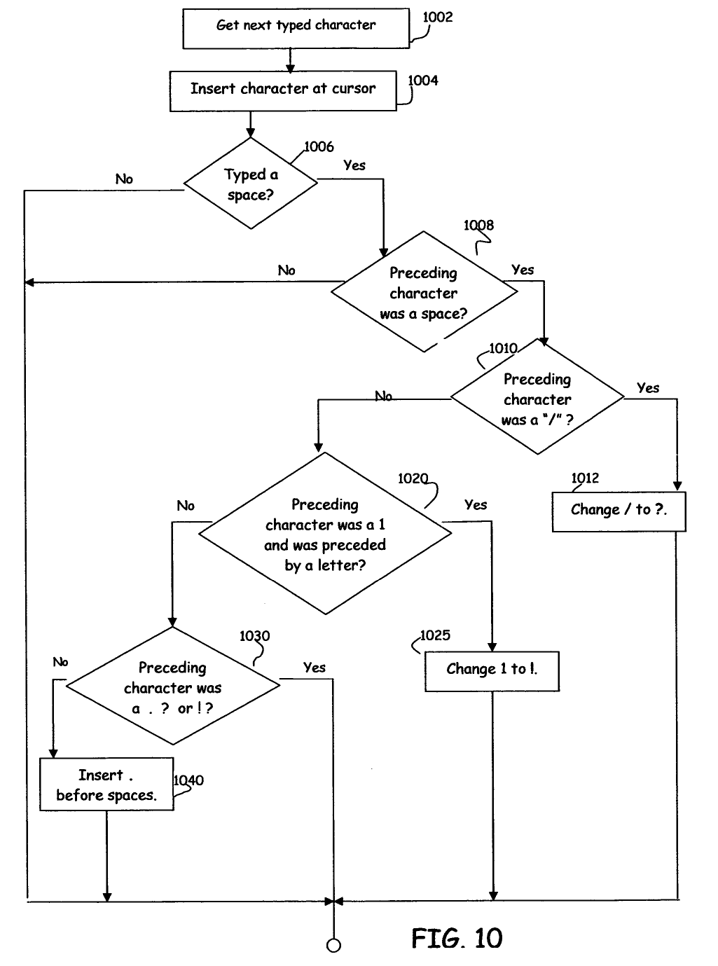

FIG. 10 further illustrates how the display in an exemplary embodiment is updated depending on which character is typed. Some text may already be present as in FIG. 7A.

In state 1002, the next character entered by the user is recorded, and in state 1004 the character is entered at the cursor, or replaces the current selection using whatever editing behavior is appropriate for the system. State 1006 and 1008 together determine whether there are now two spaces present: the just entered one, and the preceding already-present one. If so, in state 1010 we look at the character preceding the preceding character, named here as the pre-preceding character. If it is a slash/then at state 1012 the run of characters is a/followed by a space followed by the just-entered space. In this case at 1012 adjust the slash to a question mark. This causes typing of a slash in the proper context to turn into a question mark. Slash and question mark are on the same key in this embodiment on a standard typing keyboard, and differ only by the pressing of the shift-key. Together the sequence through state 1012 allows the typist to not bother with the shift key when typing question marks, which accelerates typing.

If at state 1010 the pre-preceding character was not a slash, and then if it is determined at 1020 to be a 1, then it is adjusted to an exclamation point at state 1025. This is the same sort of behavior in state 1012; in the case of state 1025 it allows typing of exclamation points without bothering with the shift key.

Note that the method is not limited to sentences that end with two spaces as detected by states 1006 and 1008. A simple extension to this exemplary embodiment is to detect other non-letter keys, such as the pressing of the Enter key, at the point of state 1006, to give the same sentence-punctuation typing acceleration for sentences that end with different characters.

If the pre-preceding character at state 1020 is not a 1, and was not a slash in 1010, then state 1030 checks whether the pre-preceding character is a valid sentence-punctuation character: period, question mark, or exclamation point. If it is, not further processing is needed for this character. For any other pre-preceding character, state 1040 inserts a period just before the two spaces detected in 1006 and 1008. This allows the typist to leave out sentence-punctuation periods entirely, using only the space at sentence ends in order to accelerate typing.

A preferred embodiment comprises the following additions to the word-correction process of FIG. 9.

When the tab key is pressed and there is a selected region of text, change the selection region to exclude the first word of the previously selected text. This allows use of the tab key to undo the last selection region expansion caused by the semicolon key.

When the colon key is pressed and there is a selected region of text, change the selection region to contain only the single word preceding the selected text. This allows a series of semicolons and then colons to be entered in order to quickly highlight a single word earlier in the text.

Typing ctrl-E toggles the word-correction process of FIG. 9 on and off. This allows the typing of unusual character sequences.

Another preferred embodiment comprises the following additions to the sentence-punctuation adjustment process of FIG. 10.

Check for the Enter key at state 1006 and 1008 as an initiation criterion, so that punctuation is adjusted for sentences at the end of a paragraph, as well as those ending in two spaces.

If the word preceding the slash at state 1010 contains other slashes and so might be a web address, proceed to state 1020 so that characters meant to remain as slashes can do so.

If the pre-preceding character is a double quote character on entry to state 1010, then apply the tests in states 1010, 1020, and 1030 to the character preceding the double quote character rather than the pre-preceding character. This gives correct punctuation for English sentences ending with a quoted phrase.

Undo any of the punctuation changes from states 1012, 1025, or 1040 if the user then types two additional spaces after the first two detected in states 1006 and 1008, for a total of four or more. This keeps extraneous punctuation from being inserted when the user is doing freeform spacing of non-sentence phrases.

Typing ctrl-E toggles the word-correction process of FIG. 10 on and off. This allows the typing of unusual character sequences.

### DETAILED DESCRIPTION OF STATE DIAGRAM

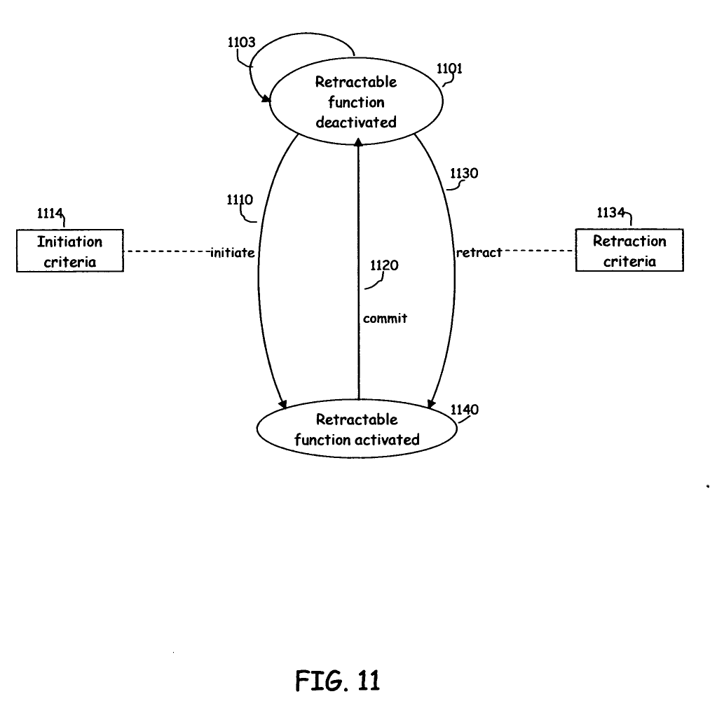

FIG. 11 illustrates the state of the retractable function activation in some embodiments in response to user character input. Initially, the system is in state 1101, with no retractable function activated. When a character is entered, the initiation criteria 1114 are checked to see whether the criteria are satisfied. If so, the retractable function is activated and the system follows arc 1110 to reach its new state 1140. An example of retractable function activation is FIG. 2B. The initiation criteria 1114 are satisfied because the semicolon key is pressed, and the retractable function is activated by setting the selection region 24. The retractable function comprises the insertion of the semicolon character into the text, as well as the setting of the selection region 24. In the embodiment shown in FIGS. 2A-2D, the insertion of the semicolon allows the retraction of the selection region later, leaving the text with the semicolon present as if the retractable function never took place. This will be shown with reference to FIGS. 5A-5C, below.

When the initiation criteria 1114 are not satisfied, the character is processed as normal, and the system proceeds through arc 1103 to remain in the deactivated state 1101. This is seen if FIG. 2A, where the entry of the characters t, e, and h are inserted normally into the text.

Once the system has the retractable function activated in state 1140, there are two arcs that can be taken in response to the next character: 1120, or 1130. If the retraction criteria 1134 are satisfied, the function is retracted 1130, leaving the system in state 1101. For instance, in the embodiment shown in FIG. 5C, a space is typed which is a retraction character and satisfies the retraction criteria 1134. The selection region 50 is unselected, leaving the cursor 52. Note that the semicolon initiation character typed in FIG. 5B remains in the text, as well as the space typed in FIG. 5C. The function has been retracted, so that the text and cursor in FIG. 5C are just as they would have been had the characters been treated as simple text entry characters.

If the retraction criteria 1134 are not satisfied, the system proceeds along arc 1120 to commit the retractable function. For instance, in FIG. 2C, the typed letter t does not satisfy the retraction criteria which are looking for a space character to be typed, the text in selection region 24 is replaced by the newly typed letter t, and the retractable function is deactivated so the system is now in state 1101 and processes future characters normally as in FIG. 2D, until the initiation criteria 1114 are triggered again.

The embodiment of FIGS. 6A-6D shows a variation on the basic pattern of FIG. 11. In FIG. 6C a second semicolon 62 is typed when the system is already in state 1140 due to the initiation by a first semicolon 62 in FIG. 6B. The second semicolon causes the selection region 66 to encompass two words, but the text no longer includes the semicolon characters, and when the space 64 is typed in FIG. 6D, the function is not retracted, because the semicolons were typed but are not present after the function is cancelled. Thus the embodiment of FIG. 6C adds a non-retractable function onto the state diagram of FIG. 11.

### CONCLUSION, RAMIFICATIONS, AND SCOPE OF THE INVENTION

Thus the reader will see that the data-entry method of the invention provides a way to greatly increase a typist's speed in executing common function without changing the keyboard layout. The invention does not adversely impact data entry performance for untrained or partially trained users, since natural character sequences are still entered unchanged. This permits increasing data-entry performance by training gradually in the use of the invention, for the lowest cost and most convenience in training.

While the foregoing detailed description contains many specificities, these should not be construed as limitations on the scope of the invention, but rather as an exemplification of selected embodiments thereof. Many other variations are possible.

For example, the same technique can be triggered by other easy-to-type keys such as the comma, rather than the semicolon used in the examples above. In another embodiment, the semicolon character causes the selection of successive preceding characters rather than words, so that the semicolon acts as an easier-to-reach and retractable backspace key.

In another embodiment, the comma character initiates a retractable subscript-entry function: if the next character typed after a comma is a space, the subscript function is retracted and the comma and space are inserted into the text, as usual. But if the next character typed after the comma is a letter or digit, that letter or digit is entered as a subscript of the preceding word, and the editing mode changes to a non-retractable subscript-entry function so that successive letters are inserted into the subscript.

Other embodiments initiate retractable function that are not editing functions. For instance, in some embodiments typing a semicolon key initiates a retractable menu-selection function, in which the next letter key typed selects a menu choice, but where typing a space after the initiation semicolon retracts the menu selection function. In one such embodiment the menu is the top-level menu for the application program. In another such embodiment the menu is a custom menu including style-change options such as b for bold, and i for italic.

Accordingly, the scope of the invention should be determined not by the embodiments illustrated, but by the appended claims and their legal equivalents.

We claim:

1. A computer-implemented method comprising:
receiving a character from a data-entry device;
initiating a retractable function if a plurality of initiation criteria are satisfied, where at least one of said initiation criteria comprises comparing said character with a predetermined initiation character; and
retracting said function if a plurality of retraction criteria are satisfied, where at least one of said retraction criteria comprises comparing said character with a predetermined retraction character,
whereby a user may perform data entry using character sequences natural to a domain, while also allowing said user to quickly perform function by using easy-to-enter character sequences that do not naturally occur in said domain.

2. The method of claim 1 wherein said initiation character and said retraction character are selected from the group consisting of the letters, digits, punctuation, space, and symbol characters.

3. The method of claim 2 wherein said initiation character is the semicolon character and wherein said data-entry device is a QWERTY keyboard.

4. The method of claim 2 wherein said data-entry device is a QWERTY keyboard, and wherein said initiation character is selected from the group consisting of the semicolon character, the colon character, the comma character, and the single-quote character.

5. The method of claim 4 wherein said retraction character is the space character.

6. The method of claim 2 wherein said retractable function consists of setting the selection region to the word preceding the cursor.

7. The method of claim 6 wherein said retraction character is the space character.

8. The method of claim 1 wherein said retraction character is a space character.

9. The method of claim 1 wherein:
said initiation character is a space character;
one of said initiation criteria comprises checking that the characters immediately preceding the cursor are a plurality of non-space characters followed by a space character; and
said retractable function comprises the adjustment of said non-space characters to have correct sentence-punctuation.

10. A computer-readable medium having instructions stored thereon, which, when executed by a computer, cause the computer to:
receive a character from a data-entry device;
initiate a retractable function if a plurality of initiation criteria are satisfied, where at least one of said initiation criteria comprises comparing said character with a predetermined initiation character;
retract said function if a plurality of retraction criteria are satisfied, where at least one of said retraction criteria comprises comparing said character with a predetermined retraction character.

11. The medium of claim 10 wherein said initiation character and said retraction character are selected from the group consisting of the letters, digits, punctuation, space, and symbol characters.

12. The medium of claim 11 wherein said initiation character is the semicolon character and wherein the keyboard is a QWERTY keyboard.

13. The medium of claim 11 wherein the data-entry device is a QWERTY keyboard, and wherein said initiation character is selected from the group consisting of the semicolon character, the comma character, and the single-quote character.

14. The medium of claim 13 wherein said retraction character is the space character.

15. The medium of claim 11 wherein said retractable function consists of setting the selection region to include at least the word preceding the cursor.

16. The medium of claim 15 wherein said retraction character is the space character.

17. The medium of claim 10 wherein said retraction character is a space character.

18. The medium of claim 10 wherein:
said initiation character is a space character;
one of said initiation criteria is that the characters in the text immediately preceding the cursor are a plurality of non-space characters followed by a space character; and
said retractable function comprises the adjustment of said non-space characters to have correct sentence-punctuation.

19. A computer-implemented method comprising:
receiving a character from a data-entry device;
adding said character to the text; and
if said character is a space and the preceding two characters in the text are a non-space character followed by a space, applying a sentence-punctuation adjustment operation to the text.

20. The method of claim 20 wherein said non-space character is a letter character, and wherein the adjustment operation is the insertion of a period after said letter character.

21. The method of claim 20, wherein said non-space character is a slash character, and wherein the adjustment operation is to replace the slash character with a question-mark character if the character preceding the slash is alphanumeric.

22. A computer-readable medium having instructions stored thereon, which, when executed by a computer, cause the computer to:
receive a character from a data-entry device;
add said character to the text; and
if said character is a space and the preceding two characters in the text are a non-space character followed by a space, apply a sentence-punctuation adjustment operation to the text.

23. The medium of claim 22 wherein the non-space character is a letter character, and wherein the adjustment operation is the insertion of a period after said letter character.

24. The medium of claim 22, wherein the non-space character is a slash character, and wherein the adjustment operation is to replace the slash character with a question-mark character if the character preceding the slash is alphanumeric.

25. A method for a computer with a data-entry device, said method comprising:
receiving a character from said data-entry device;
if said character matches a predetermined initiation character, setting the selection region to include a plurality of characters preceding the cursor; and
if said character matches a second predetermined second character and the selection region contains any characters, setting the cursor position to the end of the selection region,
whereby a user may replace a previously entered section of text by entering a single easy-to-reach initiation character and then retyping the text.

26. The method of claim 25, wherein said initiation character is a semicolon.

27. The method of claim 25, wherein said second predetermined character is a space.

28. The method of claim 25, wherein said initiation character is selected from the group consisting of the comma character, the less-than character, and the colon character.

29. The method of claim 25, wherein said plurality of characters preceding the cursor is the word preceding the cursor up to the cursor position.

30. The method of claim 25, wherein said plurality of characters preceding the cursor is the single character preceding the cursor, whereby the initiation character acts like an easier-to-type backspace key.

31. The method of claim 25, wherein when said character matches said initiation character, said character is inserted into the text and the selection region is set to include said character as well as said plurality of characters preceding the cursor.

32. The method of claim 31, wherein said initiation character is a semicolon and said second predetermined character is a space.

33. A computer-readable medium having instructions stored thereon, which, when executed by a computer, cause the computer to:
receive a character from said data-entry device;
if said character matches a predetermined initiation character, set the selection region to include a plurality of characters preceding the cursor; and
if said character matches a second predetermined character and the selection region contains any characters, set the cursor to the end of the selection region and insert said character,
whereby a user may replace a previously entered section of text by entering a single easy-to-reach initiation character and then retyping the text.

34. The medium of claim 33, wherein said initiation character is a semicolon.

35. The medium of claim 33, wherein said second predetermined character is a space.

36. The medium of claim 33, wherein said initiation character is selected from the group consisting of the comma character, the less-than character, and the colon character.

37. The medium of claim 33, wherein said plurality of characters preceding the cursor is the word preceding the cursor.

38. The medium of claim 33, wherein said plurality of characters preceding the cursor is the single character preceding the cursor, whereby the initiation character acts like an easier-to-type backspace key.

39. The medium of claim 33, wherein when said character matches the initiation character, said character is inserted into the text and the selection region is set to include said character as well as said plurality of characters preceding the cursor.

40. The medium of claim 39, wherein said initiation character is a semicolon and said second predetermined character is a space.
